(19) United States
(12) Patent Application Publication
(10) Pub. No.: US 2016/0256235 A1
(43) Pub. Date: Sep. 8, 2016

(54) DIGITAL FIVE-IN-ONE IMPLANT SURGERY AUXILIARY LOCATOR

(71) Applicant: Chun-Leon Chen, Taipei City (TW)

(72) Inventor: Chun-Leon Chen, Taipei City (TW)

(21) Appl. No.: 14/638,774

(22) Filed: Mar. 4, 2015

(51) Int. Cl. A61C 1/08

(52) U.S. Cl. CPC A61C 1/084

(57) ABSTRACT

A digital five-in-one implant surgery auxiliary locator of the invention comprises a massive body formed with a penetrating first guide hole. The massive body has an edge side, on which at least one first fitting portion correspondingly resting against neighboring teeth is disposed, and a bottom portion, on which a second fitting portion having a shape capable of correspondingly embedding with the alveolar bone, is disposed. Thus, the first and second fitting portions can be indeed mounted and fixed onto an edentulous site of a dental implant patient, and the first guide hole prevents a dental implant drill from skidding, so that the dental implant drill can be rapidly and precisely drilled into the alveolar bone and positioned to enhance a proper rate of an implant surgery.

### BACKGROUND OF THE INVENTION

(1) Field of the Invention

The invention relates to a dental aid, and more particularly to a digital five-in-one implant surgery auxiliary locator capable of precisely and rapidly making a dental implant drill be drilled into an alveolar bone and positioned according to a setting position and relatively enhancing the proper rate of the implant surgery, and this is advantageous to the wide application of the five-in-one implant surgery.

(2) Description of the Prior Art

The present inventor firstly published a five-in-one implant surgery, in which a dental implant hole is first drilled through an alveolar bone on a top portion of a tooth groove, and the pulse water enters the dental implant hole to cut the nasal sinus membrane away from the alveolar bone and make the nasal sinus membrane be separated from the alveolar bone. Then, a bone mixture is filled between the nasal sinus membrane and the alveolar bone through the dental implant hole to increase the thickness of the alveolar bone. Thereafter, the dental implant hole can be dug with a first diameter, and a threaded dental implant body with a side-cut portion can be placed into the dental implant hole.

After the dental implant body is placed and the gum tissue of the alveolar bone close to the tooth groove is cut, the gum tissue can be vertically transplanted. The gum tissue is side-cut on the alveolar bone beside the gum tissue, and the gum tissue is transplanted to abut upon the dental implant body.

However, in the step of digging the dental implant hole, because the surface of the alveolar bone at the edentulous position is not an integral plane, the drill skidding tends to be caused. More particularly, when the dentist does not have the sufficient experience or gets too tired, the drilling angle tends to become too large, and the drilling depth is too deep, thereby hurting the bone or disabling the tooth crown from being precisely positioned. Thus, there are many dentists worrying about their insufficient techniques so that the dentists are afraid to try the five-in-one implant surgery.

### SUMMARY OF THE INVENTION

In view of this, it is therefore a main object of the invention to provide a digital five-in-one implant surgery auxiliary locator capable of precisely and rapidly making a dental implant drill be drilled into an alveolar bone and positioned according to a setting position, and relatively enhancing a proper rate of the implant surgery, and this is advantageous to the wide application of the five-in-one implant surgery.

A digital five-in-one implant surgery auxiliary locator of the invention is to be mounted on an alveolar bone of a dental implant patient and to assist a dentist in implementing digging and drilling operations of a dental implant hole on an edentulous site. The digital five-in-one implant surgery auxiliary locator basically comprises a massive body formed with at least one first guide hole penetrating through the massive body. The characteristic lies in that the digital five-in-one implant surgery auxiliary locator has at least one first fitting portion, which correspondingly rests against neighboring teeth and is disposed on an edge side of the massive body, and a second fitting portion, which has a shape capable of correspondingly embedding with the alveolar bone and is disposed on a bottom portion of the massive body.

When the digital five-in-one implant surgery auxiliary locator of the invention is used, the first fitting portion and the second fitting portion may be indeed mounted and fixed onto the edentulous site of a dental implant patient and positioned, so that the first guide hole precisely faces toward the digging position of the dental implant hole preset on the alveolar bone. Thus, at least under the restriction of the first guide hole, it is possible to prevent the dental implant drill from skidding with the relatively more active and reliable means. Also, at least under the guiding of the first guide hole, the dental implant drill can be rapidly and precisely drilled into the alveolar bone and positioned to enhance the proper rate of the implant surgery, and this is more advantageous to the wide application of the five-in-one implant surgery.

Furthermore, the digital five-in-one implant surgery auxiliary locator further comprises at least one bushing for correspondingly fitting into the first guide hole, wherein the at least one bushing penetrates through a second guide hole in a top-to-bottom direction.

Furthermore, the digital five-in-one implant surgery auxiliary locator has an upwardly extended expansion-support portion disposed on the edge side of the massive body.

The digital five-in-one implant surgery auxiliary locator is formed with a bent resilient bow portion between the expansion-support portion and the massive body.

The at least one bushing has a stopping portion, which relatively projects beyond a setting height of the first guide hole and disposed on a periphery of the second guide hole.

The massive body has a top portion formed with a depressed dodge space, and the at least one first guide hole is disposed in a region of the dodge space.

The digital five-in-one implant surgery auxiliary locator further comprises at least one bushing for correspondingly fitting into the first guide hole, wherein the at least one bushing penetrates through a second guide hole in a top-to-bottom direction, the at least one bushing has a stopping portion relatively projecting beyond a setting height of the first guide hole on a periphery of the second guide hole; and an upwardly extended expansion-support portion is disposed on the edge side of the massive body, wherein a bent resilient bow portion is formed between the expansion-support portion and the massive body; wherein a top portion of the massive body is formed with a depressed dodge space, and the at least one first guide hole is disposed in a region of the dodge space.

Specifically, the digital five-in-one implant surgery auxiliary locator of the invention can prevent the dental implant drill from skidding with the relatively more active and reliable means and can precisely and rapidly make the dental implant drill be drilled into the alveolar bone and positioned according to the setting position. Thus, the proper rate of the implant surgery is significantly enhanced, and it is advantageous to the wide application of the five-in-one implant surgery. More particularly, the bushings may be selected for replacement in correspondence with different dental implant drills having different lengths and diameters, so that the aperture and depth of the dental implant hole can be gradually increased. In addition, the expansion-support portion can be utilized to expand the jowl, corresponding to the edentulous, outwardly, so that an operation space advantageous to the operation of the associated equipment is formed around the edentulous position.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial exterior view showing a digital five-in-one implant surgery auxiliary locator according to a first embodiment of the invention.

FIG. 2 is a reference view showing a used configuration of the digital five-in-one implant surgery auxiliary locator according to the first embodiment of the invention.

FIG. 3 is a cross-sectional view showing a used state of the digital five-in-one implant surgery auxiliary locator according to the first embodiment of the invention.

FIG. 4 is a reference view showing a used configuration of a digital five-in-one implant surgery auxiliary locator according to a second embodiment of the invention.

FIG. 5 is a cross-sectional view showing a used state of a digital five-in-one implant surgery auxiliary locator according to the second embodiment of the invention.

FIG. 6 is an exploded view showing a structure of a digital five-in-one implant surgery auxiliary locator according to a third embodiment of the invention.

### DETAILED DESCRIPTION OF THE PREFERRED EMBODIMENTS

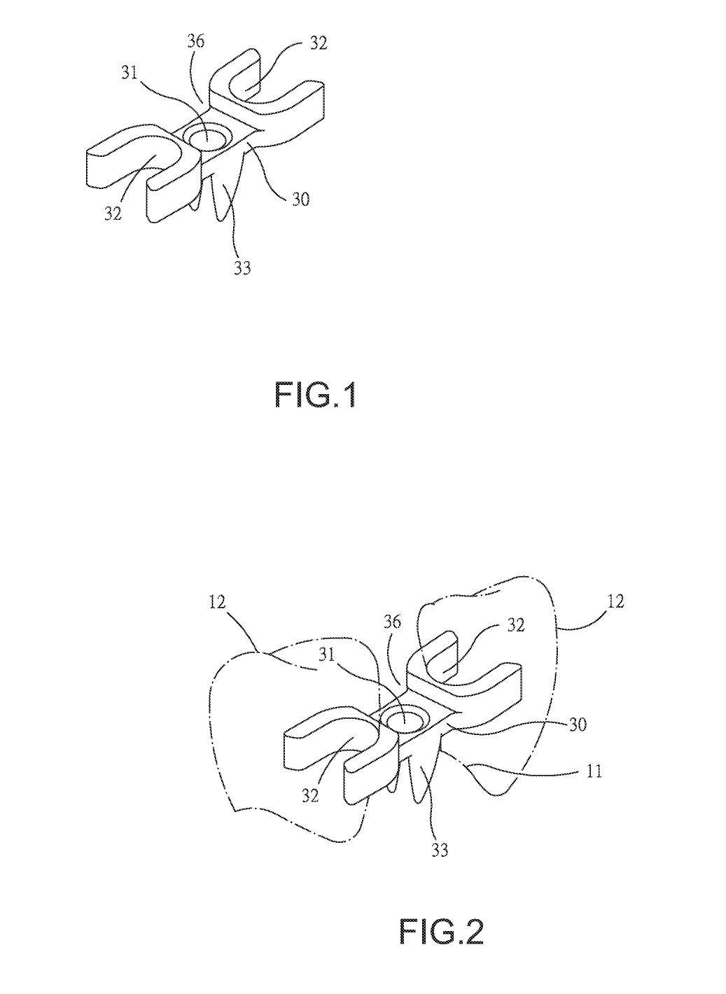

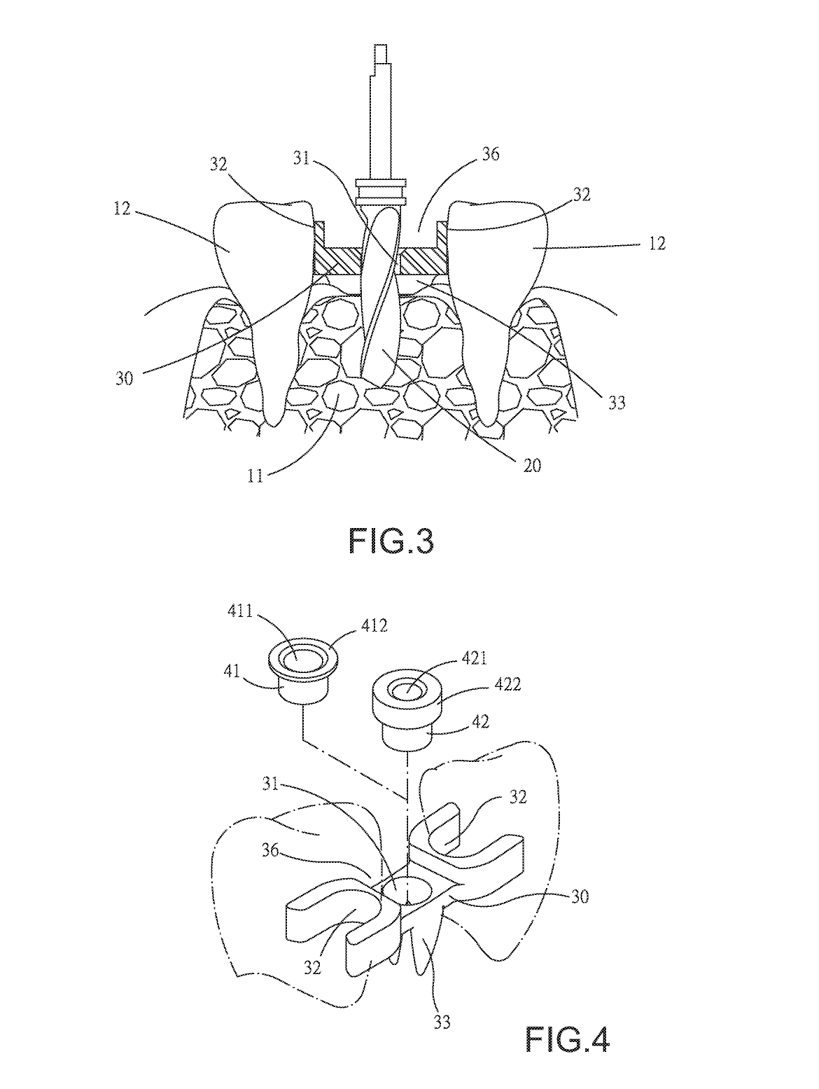

The invention mainly provides a digital five-in-one implant surgery auxiliary locator capable of precisely and rapidly making a dental implant drill be drilled into the alveolar bone and positioned according to the setting position and relatively enhancing a proper rate of the implant surgery, and this is advantageous to the wide application of the five-in-one implant surgery. As shown in FIGS. 1 to 3, the digital five-in-one implant surgery auxiliary locator of the invention is to be mounted on an alveolar bone 11 of a dental implant patient, to assist the dentist in implementing digging and drilling operations of the dental implant hole on an edentulous site. The digital five-in-one implant surgery auxiliary locator basically has at least one first guide hole 31 penetrating through a massive body 30.

The characteristic of the invention lies in that the digital five-in-one implant surgery auxiliary locator has: at least one first fitting portion 32, which is disposed on the edge side of the massive body 30 and correspondingly rests against neighboring teeth 12; and a second fitting portion 33, which is disposed on the bottom portion of the massive body 30 and has a shape capable of correspondingly embedding with an alveolar bone 11.

In principle, when the digital five-in-one implant surgery auxiliary locator of the invention is used, the first fitting portion 32 and the second fitting portion 33 are indeed mounted and fixed onto the edentulous site of a dental implant patient and positioned, and the first guide hole 31 precisely faces toward a preset dental implant hole digging position of the alveolar bone 11. Thus, at least under the restriction of the first guide hole 31, it is possible to prevent a dental implant drill 20 from skidding with a relatively more active and reliable means. In addition, at least under the guiding of the first guide hole 31, the dental implant drill 20 can be rapidly and precisely drilled into the alveolar bone 11 and positioned to enhance the proper rate of the implant surgery, and this is more advantageous to the wide application of the five-in-one implant surgery.

As shown in FIGS. 4 and 5, when the digital five-in-one implant surgery auxiliary locator of the invention is implemented, the digital five-in-one implant surgery auxiliary locator may further comprise at least one bushing (a bushing 41 and a bushing 42 shown in the drawing) to be correspondingly fit with the first guide hole 31, wherein the at least one bushing 41 (42) penetrates through a second guide hole 411 (421) in a top-to-bottom direction. Upon the actual digging operation of the dental implant hole, the bushing 41 (42) can be selected for replacement according to the different aperture of the second guide hole 411 (421), so that different dental implant drills 20 with different diameters can be used to gradually enlarge the aperture of the dental implant hole. Upon implementation, the at least one bushing 41 (42) is preferably rotatable relatively to the massive body 30 to prevent the wear between the dental implant drill 20 and the bushing 41 (42) from being caused.

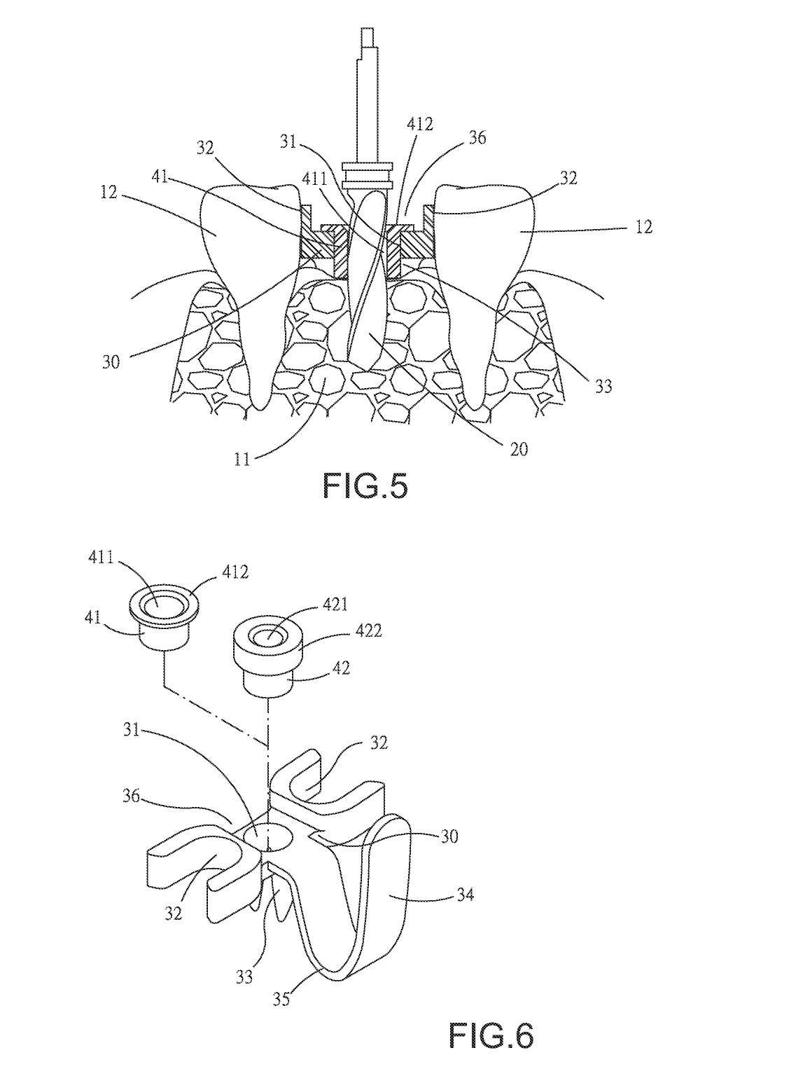

As shown in FIG. 6, the digital five-in-one implant surgery auxiliary locator of the invention may further have an upwardly extended expansion-support portion 34 on the edge side of the massive body 30, wherein the expansion-support portion 34 can be utilized to expand the jowl, corresponding to the edentulous position, outwardly, so that an operation space advantageous to the operation of the associated equipment is formed around the edentulous position.

Of course, the overall digital five-in-one implant surgery auxiliary locator, as shown in the drawing, comprises at least one bushing 41 (42) to be correspondingly fit into the first guide hole 31. The structural patterns, in which the at least one bushing 41 (42) penetrates through a second guide hole 411 (421) in a top-to-bottom direction, and an upwardly extended expansion-support portion 34 is disposed on the edge side of the massive body 30, are preferred. In addition, the digital five-in-one implant surgery auxiliary locator may be formed with a bent resilient bow portion 35 between the expansion-support portion 34 and the massive body 30. Furthermore, regardless of whether the edge side of the massive body 30 of the digital five-in-one implant surgery auxiliary locator has an upwardly extended expansion-support portion 34, the at least one bushing 41 (42) may further have a stopping portion 412 (422) relatively projecting beyond the setting height of the first guide hole 31 on the periphery of the second guide hole 411 (421). When the operation of digging the dental implant hole is actually performed, different bushings 41 (42) with different heights of the stopping portions 412 (422) can selected for replacement, so that the dental implant drills 20 with different lengths can be used to gradually increase the depth of the dental implant hole.

It is worth mentioning that regardless of whether an upwardly extended expansion-support portion 34 is disposed on the edge side of the massive body 30 of the digital five-in-one implant surgery auxiliary locator of the invention, or at least one bushing 41 (42) is provided, a depressed dodge space 36 may be formed on the top portion of the massive body 30. The at least one first guide hole 31 is disposed in the region of the dodge space 36 so that the top portion of the massive body 30 is formed with an operation space advantageous to the operation of the associated equipment.

Similarly, the top portion of the massive body 30 is formed with a depressed dodge space 36, and the at least one first guide hole 31 is disposed in the region of the dodge space 36. A stopping portion 412 (422) relatively projecting beyond the setting height of the first guide hole 31 is disposed on a periphery the second guide hole 411 (421) of the at least one bushing 41 (42), and the at least one bushing 41 (42) is preferably in the form of the structural pattern rotatable relatively to the massive body 30. Specifically, the digital five-in-one implant surgery auxiliary locator of the invention can prevent the dental implant drill from skidding with the relatively more active and reliable means and can precisely and rapidly make the dental implant drill be drilled into the alveolar bone and positioned according to the setting position. Thus, the proper rate of the implant surgery is significantly enhanced, and it is advantageous to the wide application of the five-in-one implant surgery. More particularly, the bushings may be selected for replacement in correspondence with different dental implant drills having different lengths and diameters, so that the aperture and depth of the dental implant hole can be gradually increased. In addition, the expansion-support portion can be utilized to expand the jowl, corresponding to the edentulous, outwardly, so that an operation space advantageous to the operation of the associated equipment is formed around the edentulous position.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A digital five-in-one implant surgery auxiliary locator to be mounted on an alveolar bone of a dental implant patient and to assist a dentist in implementing digging and drilling operations of a dental implant hole on an edentulous site, the digital five-in-one implant surgery auxiliary locator basically comprising a massive body formed with at least one first guide hole penetrating through the massive body, wherein the characteristic lies in that:
the digital five-in-one implant surgery auxiliary locator has at least one first fitting portion, which correspondingly rests against neighboring teeth and is disposed on an edge side of the massive body, and a second fitting portion, which has a shape capable of correspondingly embedding with the alveolar bone and is disposed on a bottom portion of the massive body.

2. The digital five-in-one implant surgery auxiliary locator according to claim 1, further comprising at least one bushing for correspondingly fitting into the first guide hole, wherein the at least one bushing penetrates through a second guide hole in a top-to-bottom direction.

3. The digital five-in-one implant surgery auxiliary locator according to claim 1, wherein the digital five-in-one implant surgery auxiliary locator has an upwardly extended expansion-support portion disposed on the edge side of the massive body.

4. The digital five-in-one implant surgery auxiliary locator according to claim 3, wherein the digital five-in-one implant surgery auxiliary locator is formed with a bent resilient bow portion between the expansion-support portion and the massive body.

5. The digital five-in-one implant surgery auxiliary locator according to claim 2, wherein the at least one bushing has a stopping portion, which relatively projects beyond a setting height of the first guide hole and disposed on a periphery of the second guide hole.

6. The digital five-in-one implant surgery auxiliary locator according to claim 1, wherein the massive body has a top portion formed with a depressed dodge space, and the at least one first guide hole is disposed in a region of the dodge space.

7. The digital five-in-one implant surgery auxiliary locator according to claim 1, further comprising at least one bushing for correspondingly fitting into the first guide hole, wherein the at least one bushing penetrates through a second guide hole in a top-to-bottom direction, the at least one bushing has a stopping portion relatively projecting beyond a setting height of the first guide hole on a periphery of the second guide hole; and an upwardly extended expansion-support portion is disposed on the edge side of the massive body, wherein a bent resilient bow portion is formed between the expansion-support portion and the massive body; wherein a top portion of the massive body is formed with a depressed dodge space, and the at least one first guide hole is disposed in a region of the dodge space.
